(19) United States
(12) Patent Application Publication
(10) Pub. No.: US 2023/0405606 A1
(43) Pub. Date: Dec. 21, 2023

(54) CENTRIFUGAL SCREW, AND SOLID BOWL SCREW CENTRIFUGE

(71) Applicant: FLOTTWEG SE, Vilsbiburg (DE)

(72) Inventor: Michael Beywl, Bodenkirchen (DE)

(21) Appl. No.: 18/035,618

(22) PCT Filed: Nov. 9, 2021
(86) PCT No.: PCT/EP2021/081035

§ 371 Date: May 5, 2023

(30) Foreign Application Priority Data
Nov. 9, 2020 (DE) 10 2020 129 485.9

(51) Int. Cl. B04B 1/20

(52) U.S. Cl. CPC B04B 1/20; B04B 2001/2041; B04B 2001/2058

(57) ABSTRACT

The invention relates to a centrifugal screw (10) comprising a substantially tubular screw hub (15) and a screw flight (20), wherein at least some portions of a root (21) of the screw flight (20) are attached directly to the tubular screw hub (15). According to the invention, rods (30) are formed between at least two turn portions (25) in the longitudinal direction (R) of the centrifugal screw (10), said rods (30) being entirely or nearly entirely located at a distance from the screw hub (15).

The invention relates to a centrifugal screw having an essentially tube-shaped screw hub and a screw spiral, wherein a spiral basis of the screw spiral is at least in sections directly attached to the tube-shaped screw hub, according to the preamble of claim 1. Furthermore, the invention relates to a solid bowl screw centrifuge according to claim 15.

Solid bowl screw centrifuges are characterized by a drum having a closed or complete envelope. The drum is rotated at a high rotational speed, whereby a multiphase mixture located within the drum can be separated at least into a heavy phase and a light phase. The heavy phase usually is a solid phase transported out of the drum by a screw, i.e., a centrifugal screw. For this purpose, the screw is mounted within the drum to be rotatable relative to the drum and has a screw spiral. The screw spiral is arranged around a screw hub.

The screw spiral glides along the inner side or the inner envelope surface of the drum and thus conveys the product of the heavy phase to an axial end area of the drum. At the end of the drum, the product of the heavy phase is conveyed out from the drum. The multiphase mixture to be clarified hence is located between the inner side of the drum and the screw hub.

In certain solid bowl screw centrifuges, a large pond depth is aspired in particular for sewage purification reasons. At the same time, however, the pond depth is limited by the diameter of the screw hub and there resulting buoyancy and deposition effects of the mixture to be clarified or the light phase.

In order to increase the process-technological performance of modern solid bowl screw centrifuges, in particular of modern decanter centrifuges, it is possible for the pond depth ratio of the solid bowl screw centrifuge to be increased.

For achieving a good dynamical behavior of the centrifugal screw or the rotor itself, however, torsional rigidity as high as possible is required. In the hitherto known constructions in conjunction with a centrifugal screw of a solid bowl screw centrifuge it is therefore necessary to make a compromise between a pond depth ratio as large as possible and high torsional rigidity of the centrifugal screw that is as high as possible.

The invention is therefore based on the task to provide a centrifugal screw which due to the further developed constructive structure has both high torsional rigidity and can be used in conjunction with a large pond depth ratio.

The invention is further based on the task to propose a further developed solid bowl screw centrifuge. The solid bowl screw centrifuge to be further developed in particular with respect to the centrifugal screw.

According to the invention, this task with respect to the centrifugal screw is solved by the subject matter of claim 1. With respect to the solid bowl screw centrifuge, the task is solved by the subject matter of claim 15. The subclaims comprise at least appropriate configurations and further developments.

Specifically, the task is solved by a centrifugal screw having an essentially tube-shaped screw hub and a screw spiral, wherein a spiral basis of the screw spiral is directly attached to the tube-shaped screw hub at least in sections.

According to the invention, rods are designed in the longitudinal direction of the centrifugal screw between at least two winding portions of the screw hub, wherein the rods are designed to be completely or almost completely spaced from the screw hub.

The longitudinal direction of the screw hub is essentially defined by the orientation of the longitudinal axis of a screw hub. The longitudinal axis of a screw hub is the axis, around which the screw hub rotates when being used.

The longitudinal direction is preferably defined to be the direction of transport of the solid material discharge.

In the longitudinal direction of the centrifugal screw, this screw may have at least two different portions. A first portion is in this case the cylindrical longitudinal portion. A further portion following in the longitudinal direction preferably is the portion at the solid-discharge end.

The medium to be processed or separated by means of the centrifugal screw may be a multiphase medium. The medium may be, for example, a two-phase mixture or a three-phase mixture. It is also possible to use the centrifugal screw according to the invention for separating a three-phase mixture, wherein a solid phase and two liquid phases are present.

Such a screw hub has to be understood to be a tube-shaped screw hub which essentially is designed to be tube-shaped, which is basically designed to be tube-shaped, but can have portions at the frontal sides having other geometries and/or components. In other words, the preponderant proportion of the screw hub should be designed to be tube-shaped.

As a spiral basis of the screw spiral, the interior portion of the screw spiral is to be understood which is designed to be opposite the spiral tip. At least in sections, the spiral basis of the screw spiral is directly attached to the screw hub.

In a preferred embodiment of the invention, the spiral basis of the screw spiral is directly attached to the tube-shaped screw hub at least to 30%, particularly preferred at least to 50%.

Such an attachment has to be understood to be a direct attachment of the screw spiral to the screw hub which is performed without designing further intermediary attachment elements or further distance elements such as, i.e., webs.

Preferably, the screw spiral and the screw hub are welded together. A further embodiment of the invention provides a one-piece design of the screw spiral and the screw hub, so that by using a 3D-welding method, for example, the screw spiral is attached to the screw hub already during the principal realization of the screw spiral and the screw hub.

It is furthermore possible for the spiral basis of the screw spiral to be attached at most to 30%, particularly preferred at most to 50% directly to the tube-shaped screw hub. It is particularly provided in such an embodiment of the invention that free spaces or recesses are designed between the attachment portions in which the screw spiral is directly connected to the screw hub. In the free spaces or recesses, the spiral basis of the screw hub preferably is not connected to further components and/or portions. In these free spaced or recesses, passage openings are then formed. Such a realization of passage openings enables the liquid or the centrate in the area of the screw hub to flow off well.

The centrifugal screw moreover has rods. The rods run in the longitudinal direction of the centrifugal screw. Preferably, the rods run in parallel to the longitudinal direction of the centrifugal screw. This concerns in particular such an embodiment of the invention in which the rods are designed to be straight.

Due to the further developed construction of the centrifugal screw, it is possible to make such a screw hub available which has a comparably small outer diameter. Due to that, a pond depth ratio to be designed in a solid bowl screw centrifuge can be increased. The process-technological performance is increased due to the screw hub having the small outer diameter. By means of the additionally designed rods, the bending rigidity of the centrifugal screw can be increased. The dynamic properties of the centrifugal screw can be improved for this reason.

Due to the construction of the centrifugal screw according to the invention, larger length/diameter ratios can be realized in conjunction with a centrifugal screw to be constructed. This can be traced back to the fact, that a generating imbalance of the two-rotor system has less effects on the operating behavior. This in turn can be traced back on the fact that the entire system has a higher bending rigidity due to the construction of the centrifugal screw according to the invention.

Furthermore, the construction of the centrifugal screw according to the invention causes the liquid or the centrate to flow off well, in particular in the area of the screw hub. The dimension of the screw hub can be decreased significantly due to the construction according to the invention.

As a winding portion of a screw spiral, such a portion of the screw spiral is to be understood which corresponds to a 360°-rotation of the screw spiral.

If a rod is designed to be completely spaced from the screw hub, the rod is not connected directly to the screw hub. An indirect attachment is possible, for example, by means of further components.

If a rod is designed to be almost completely spaced from the screw hub, the rod is preferably attached to the screw hub only at its ends (rod ends). The far bigger proportion of the rod, however, is spaced from the screw hub. The distance between the rod and the screw hub in such an embodiment of the invention, however, preferably is not equal across the total longitudinal extension of the rod.

The rods may be designed between at least two winding portions such that they are attached respectively to a front side of a first winding portion and a rear side of a further winding portion. The further winding portion may be, for example, the nearest or neighboring winding portion.

It is furthermore possible that the further winding portion is a winding portion located remotely. In such a case, the rods are to be guided through the intermediate winding portions.

It is possible for the rods to extend across several winding portions. This enables a particularly high stability or bending rigidity of the centrifugal screw to be produced.

In an embodiment of the invention, the rods may be arranged in parallel to one another. Preferably, the rods in this case are also arranged or oriented in parallel to the longitudinal direction of the centrifugal screw.

It is possible for the rods to be of equal design. The equal configuration of the rods, for example, may concern the cross-sectional shape of the rods. It is moreover possible for the equality being given with respect to the length of the rods.

The cross-section of the rods may be present in different shapes. A particularly preferred embodiment of the invention provides a circular cross-sectional shape of the rods. Such rods are to be produced or to be obtained simply.

Further possibilities are given with respect to cross-sectional shapes designed to be rectangular or square. A rectangular design of the cross-sectional surface is advantageous with respect to the variously great bending moments therewith achieved in the radial direction and in the circumferential direction.

It is furthermore possible for the rods to have triangular shape in cross-section. Rods having such a triangular shape may be attached particularly well in conjunction with the winding portions.

It is moreover possible for the rods to be designed to be hollow-cylindrical. By means of such hollow-cylindrical rods, high bending moments can be achieved at low material expenditure and low weight.

In a further embodiment of the invention, it is possible for the rods to be guided through openings of the screw spiral. This enables a rod to be guided across several winding portions. The openings of the screw spiral may have a shape which is complementary to that of the rods. It is in particular possible for the openings to be designed to be circular and/or elliptical and/or cam-shaped.

Preferably, the openings designed in the screw spiral are all of equal design. This facilitates the production process. Apart from that, the openings of the screw spiral are designed to be flush to one another in the longitudinal direction so that the rods can be guided simply through the openings. The openings of the screw spiral per winding portion preferably correspond to the number of rods being designed.

The number of rods may be selected variably. It has been shown that designing 4 to 16 rods, in particular 6 to 12 rods, in particular 8 rods, is advantageous with respect to the bending rigidity of the centrifugal screw. In other words, the mentioned number of rods is sufficient for the bending rigidity of the centrifugal screw to be achieved at simultaneously reducing the outer diameter or the tube-shaped screw hub.

In an embodiment of the invention, it is possible for the openings of the screw spiral to be designed as longitudinal recesses originating from the spiral basis.

It is possible for the recesses to be designed in a slot-shape, wherein one end of the slot merges into the spiral basis. This enables the rods to be mounted simply in the spiral basis. In such an embodiment of the invention, the longitudinal recess or the slot-shaped recess preferably is designed such that the width of the recess is reduced starting from the spiral basis in the direction of the further end of the recess. In other words, the width of the longitudinal recess or the width of the slot-shaped recess decreases starting from the spiral basis in the direction of the second tip of the recess or in the direction of the spiral tip.

Preferably, the width of the longitudinal recess or the slot-shaped recess in the area of the second end is selected such that the rods, when being introduced into the longitudinal recess or the slot-shaped recess can be pushed into the area of the second end of the longitudinal recess or the slot-shaped recess and can be fixed there in a clamping manner.

In the area of the longitudinal recesses or the slot-shaped recesses, the already described passage openings can be designed.

The tube-shaped screw hub as compared to known screw hubs of centrifugal screws has a reduced outer diameter without further stabilizing elements. In order to be able to provide a centrifugal screw in the same size, the height of the screw spiral thus increases in this case. Due to the forward tilt of the screw spiral in conjunction with a high centrifugal force load, this results in high bending tensions in the screw spiral. This effect is additionally reinforced by the screw spiral pressure. Due to designing rods running in the longitudinal direction of the centrifugal screw, the constructively conditioned high screw spiral height is stabilized. Thus, screw spiral cracks will not occur. The natural frequency of the screw spiral itself will increase.

The ratio of the diameter of the screw hub to the outer diameter of the screw spiral preferably is 0.6, in particular 0.5, particularly preferred 0.4. The diameter of the screw hub concerns in this case the outer diameter of the screw hub. The outer diameter of the screw spiral relates to the diameter measured at the spiral tip in each case.

The ratio of the diameter of the circle on which the rods are arranged to the outer diameter of the screw spiral preferably is 0.8, in particular 0.7, particularly preferred 0.6. The diameter of the circle on which the rods are arranged is an imaginary circle line. The ratio of the diameter of the circle on which the rods are arranged to the outer diameter of the screw spiral is in each case higher than the ratio of the diameter of the screw hub to the outer diameter of the screw spiral.

Preferably, the ratio of the diameter of the circle on which the rods are arranged to the outer diameter of the screw spiral is by 0.2 greater the ratio of the diameter of the screw hub to the outer diameter of the screw spiral.

The ratio of the diameter of a rod to the outer diameter of the screw spiral preferably is 0.15, in particular 0.1, particularly preferred 0.05. The described ratio is related to the diameter of an individual rod, wherein the diameters of all of the rods preferably are of equal design.

In a possible embodiment of the invention, the rods essentially extend completely across a cylindrical longitudinal portion of the centrifugal screw.

The cylindrical longitudinal portion of the centrifugal screw preferably is the portion of the screw hub which essentially has a tube-shaped design. Adjoining the cylindrical longitudinal portion, preferably a portion at the solid-discharge end of the centrifugal screw is designed.

The cylindrical longitudinal portion of the centrifugal screw in particular is related to that part of the centrifugal screw which is in conjunction with the separating space within the drum of the solid bowl screw centrifuge. In the cylindrical longitudinal portion, moreover the inflow area of the centrifugal screw is designed.

As such an extension of the rods being performed essentially completely across the cylindrical longitudinal portion of the centrifugal screw, in particular such an extension has to be understood which does not necessarily have to be up to the outermost end of the cylindrical longitudinal portion and may slightly be spaced from the frontal side of the area of the centrifugal screw comprising the cylindrical longitudinal portion of the centrifugal screw.

It is furthermore possible for the rods to extend at least in sections starting from a/the cylindrical longitudinal portion of the centrifugal screw up into a discharge-side portion of the centrifugal screw.

The portion at the solid-discharge end of the centrifugal screw is that portion of the centrifugal screw in the area of which the solid discharge of the solid bowl screw is performed.

Preferably, the portion at the solid-discharge end comprises an end of the screw hub or a frontal side of the screw hub.

The portion at the solid-discharge end may, for example, be designed in a cone shape. When such a cone shape is designed, it is formed by a closed envelope surface. The cone shape may also be designated to be a truncated cone shape in the longitudinal section through the screw hub.

The screw hub of the portion at the solid-discharge end of the centrifugal screw may moreover be designed as a cylinder portion and/or a cylindrical tube portion. The cylinder portion and/or the cylindrical tube portion, for example, may be attached to the cylindrical longitudinal portion by means of a connecting flange.

It is possible that the cylinder portion and/or the cylindrical tube portion is/are designed to be stepped such that the cylinder portion and/or the cylindrical tube portion in the longitudinal direction of the screw hub have/has at least two portions having different diameters.

By means of such a step shape, an improved reduction with respect to the undesired generation of bottlenecks inside of the drum of a solid bowl screw centrifuge can be achieved in the area of the solid discharge. The solid material to be transported and discharged can be correspondingly relaxed.

In a further embodiment of the invention, it is possible for the portion at the solid-discharge end to have a double truncated cone shape.

The double truncated cone shape preferably is designed such that the imaginary base surfaces of two truncated cones adjoin each other. The double truncated cone shape preferably is designed such that the maximum diameter of the double truncated cone shape neither is formed at a connecting portion to the cylindrical longitudinal portion nor at a frontal side of the screw hub associated to the portion at the solid-discharge end.

The extension of the rods in at least one portion of the portion at the solid-discharge end of the centrifugal screw is in particular advantageous in such an embodiment of the portion at the solid-discharge end, according to which the portion at the solid-discharge end has a double truncated cone shape. In such an embodiment of the invention, the rods may extend up to the truncated cone shape that has firstly be arranged in the longitudinal direction of the solid bowl screw centrifuge. It is in particular possible for the rods to extend in this case up to the area of the two base surfaces of the two truncated cones adjoining each other.

In a further embodiment of the invention, metal sheets may be designed between the screw hub and individual rods and/or rod portions.

Preferably, the metal sheets are both connected to the surface of the screw hub and to individual rods and/or rod portions. In particular, the metal sheets are welded to the screw hub and individual rods and/or rod portions.

The metal sheets serve in particular for additionally rigidifying the centrifugal screw. Such metal sheets in particular may be designed in the area of the cylindrical longitudinal portion pointing in the direction of the first frontal side of the screw hub. In other words, the metal sheets may be designed in particular in the constructional proximity to the first frontal side of the screw hub. The first frontal side of the screw hub is the frontal side which is designed to be opposite the portion at the solid-discharge end.

The described metal sheets, as seen in particular in the longitudinal direction of the screw hub, may be designed in a first third, in particular a first quarter, in particular a first fifth part of the cylindrical longitudinal portion.

At least one of the metal sheets can have at least one metal sheet opening. Preferably, at least one of the metal sheets is designed to be perforated. This serves, on the one hand, for reducing weight. On the other hand, the openings serve for improving the flow properties within the drum of the solid bowl screw centrifuge.

It is possible for the rods to be designed to be bent at least in sections. Designing bent rods increases the stability and bending rigidity of the centrifugal screw.

In a preferred embodiment of the invention with respect to designing bent rods, the bent rods preferably are positioned in the longitudinal direction of the centrifugal screw such that the bent rods form a rod body, the largest outer diameter of which is designed in a middle segment of the centrifugal screw. Such a middle segment preferably is a portion designed in the area of the longitudinal portion of the centrifugal screw. The middle segment preferably is designed to be spaced both from the first frontal side of the screw hub and from the second frontal side of the screw hub.

Such a structure is to be understood to be a rod body, which has not to be designed to be coherent. Such a structure of several rods has to be understood to be a rod body, which are positioned such to one another that they form a kind of body in the arranged shape. The rod body may have, for example, a spindle-shaped base shape. Such a spindle shape is characterized in that the ends of the spindle shape, as seen in the longitudinal direction, have a smaller outer diameter than a central bulging portion.

In a further embodiment of the invention, it is possible for at least one rod, preferably the rods, to be respectively bent at several places such that several bending portions are formed. Preferably, such rods bent at several places are positioned in the longitudinal direction of the centrifugal screw such that the rods bent at several places form a rod body, the largest outer diameter of which is designed in the middle segment of the centrifugal screw. Due to the fact that the rods are bent at several places, the attachment of the rods can be facilitated since the rods can respectively be designed to be flatter or flatly tapering in the area of the ends.

The screw hub of the centrifugal screw can be designed as a tube screw hub. Such a tube screw hub preferably has openings in the inflow area, in particular rectangular openings into which wear bushes may be inserted. By means of such wear bushes it is possible to considerably extend the lifetime of the screw hub, since the bushes can be removed and replaced after a corresponding wear. It is moreover possible for the screw hub to be designed as a slot screen hub. Preferably, such a slot screw hub has four slots evenly distributed across the radius in the hub wall.

By means of selecting different screw hub variants it is possible for the centrifugal screw according to the invention to be used in different fields of application.

A further subordinate aspect of the invention relates to a solid bowl screw centrifuge comprising a centrifugal screw located within a drum, wherein the centrifugal hub is designed according to the invention.

With respect to the solid bowl screw centrifuge, reference is made to the advantages explained in conjunction with the centrifugal screw. Furthermore, the solid bowl screw centrifuge alternatively or additionally may have individual or a combination of several features previously mentioned with respect to the centrifugal screw.

The invention is explained in more detail below while referring to the attached drawings.

The illustrated embodiments represent examples, how the centrifugal screw according to the invention may be designed.

Shown are in:

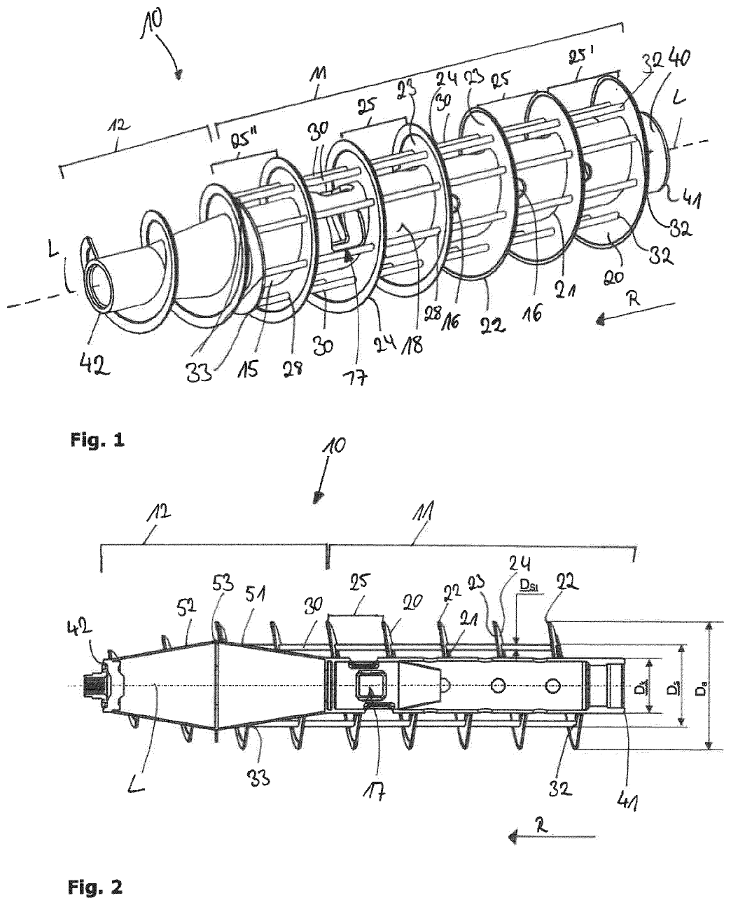

FIG. 1 a perspective view of a centrifugal screw according to the invention according to a first exemplary embodiment;

FIG. 2 a longitudinal sectional view through a centrifugal screw according to the invention according to a further exemplary embodiment according to the invention; and

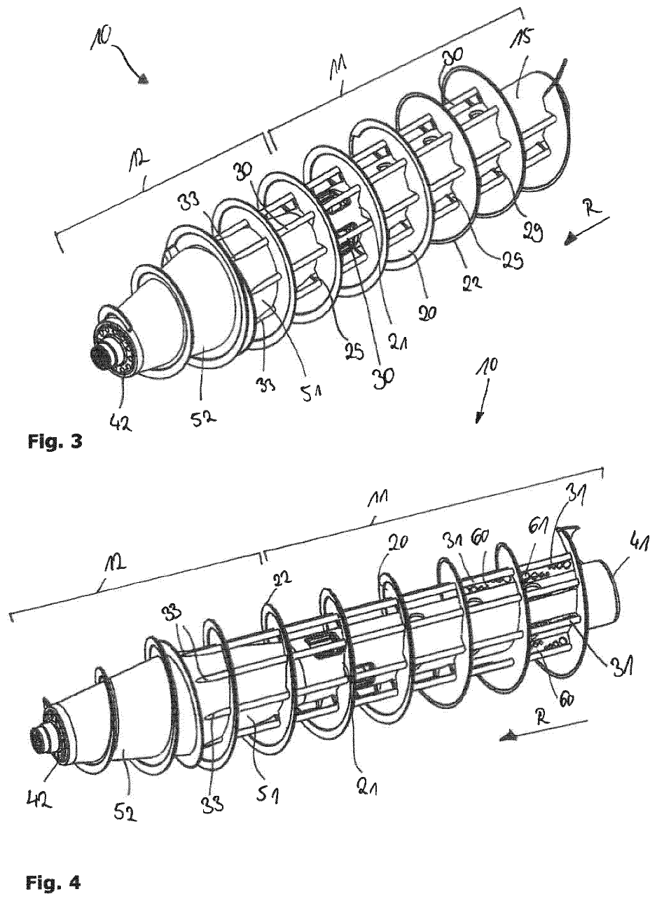

FIGS. 3-6 further embodiments according to the invention of a centrifugal screw according to the invention in a perspective representation or in a side view.

In the following, the same reference numerals will be used for equal parts or parts of equal action.

FIG. 1 shows the principal construction of a centrifugal screw 10 according to the invention. The representation is a perspective representation.

The centrifugal screw 10 has a screw hub 15 and a screw spiral 20. The screw hub 15 essentially is designed to be tube-shaped. Into the tube-shaped base structure of the screw hub 15, individual openings 16 are introduced.

Furthermore, the inflow area 17 of the screw hub 15 is represented. In the inflow area 17, several rectangular openings are designed. In the represented example, it is a so-called bushing screw. That means that wear bushings can be introduced into the openings of the inflow area 17. These wear bushings can correspondingly be exchanged and renewed.

The centrifugal screw 10 can essentially be divided into two portions. In this case, there is a cylindrical longitudinal portion 11 and a portion 12 at the solid-discharge end. In the cylindrical longitudinal portion 11, the screw hub 15 essentially has a cylindrical shape. The portion 12 at the solid-discharge end has to be understood as being such a functional portion that serves in particular for the transport into the direction of the solid-discharge of the solid matter separated from the material to be processed.

The cylindrical longitudinal portion 11 is designed in the longitudinal direction R as the first portion. The portion 12 at the solid-discharge end follows.

The longitudinal direction R essentially runs in parallel to the longitudinal axis L of the screw hub 15. The longitudinal direction R is defined in the represented example as being the direction of the transport of the solid discharge. The solid matter transport in the representation of FIGS. 1-6 each is performed from the right to the left side.

It can be recognized that the spiral basis 21 of the screw spiral 20 is directly attached to the tube-shaped screw hub 15 or directly to the outside 18 of the screw hub 15. In the represented example, the screw spiral 20 is directly connected to the outside 18 of the screw hub 15 across the complete longitudinal extension of the screw hub 15. Preferably, the screw spiral 20 and the screw hub 15 are welded together.

In the cylindrical longitudinal portion 11, the screw spiral 20 has a constant outer diameter. The outer diameter of the screw spiral 20 is designed at the spiral tip 22. In the portion 12 at the solid-discharge end, the screw spiral 20 is designed to be conically tapering. This means that the outer diameter of the screw spiral 20 decreases in the longitudinal direction R in the portion 12 at the solid-discharge end.

In the longitudinal direction R of the centrifugal screw, rods 30 are designed between at least two winding portions 25. The rods 30 are designed to be spaced from the screw hub 15.

As a winding portion 25, in each case a 360°-winding of the screw spiral 20 has to be understood. In the represented example, the rods 30 extend from the first winding portion 25′ to the last winding portion 25″ of the cylindrical longitudinal portion 11.

The rods 30 are arranged to be evenly distributed in the circumferential direction. In the present case, eight rods 30 are designed. The rods 30 are guided through openings 28 of the screw spiral 20.

It would be furthermore possible for the rods 30 to consist of partial segments, i.e., of individual rod portions which are each attached individually between the winding portions 25. For this purpose, an attachment would be respectively made on the front side 23 of a first winding portion and on the rear side 24 of a further, i.e., subsequent winding portion 25.

In an arrangement of individual rod portions, the rods thus have not to be positioned in relation to the winding portions to be flush. An offset arrangement of the individual rods or rod portions could be made.

In the present example, the rods 30 have circular cross sections. The openings 28 of the screw spiral 20, for example, have the same geometry as the cross-sectional geometry of the rods 30.

In the present case, the openings 28 could be designed to be circular. In order to be able to position long individual rods 30 across several spiral portions 25, the openings 28 of the individual winding portions 25 need to be arranged to be flush to each other.

Further opening shapes, for example, may be elliptical or cam-shaped.

In the present example, the rods 30 essentially extend completely across the cylindrical longitudinal portion 11 of the centrifugal screw 10. As an essentially complete extension, such an extension has to be understood in the present case, which starts with the first winding portion 25′ and ends with the last winding portion 25″. In the area of the bearing reception 40, no rods 30 are arranged.

In other words, the rods 30 do not protrude up to the first frontal side 41 of the screw hub 15. The frontal side 41 is in the present case the frontal side 41 which comes first into to the longitudinal direction R. This first frontal side 41 is arranged to be opposite to the second frontal side 42 of the screw hub 15. The second frontal side 42, however, is to be understood to be a part or portion of the portion 12 at the solid-discharge end of the centrifugal screw 10.

In FIG. 2, a centrifugal screw 10 according to the invention is represented in a longitudinal cut representation. A constructional difference is with respect to the portion 12 at the solid-discharge end. This is constructed in the represented example having a double truncated cone shape.

The double truncated cone shape is formed by adjacent truncated cones 51 and 52. The first truncated cone 51 is arranged such relative to the second truncated cone 52 that the respective (imaginary) base surfaces of the truncated cones 51 and 52 are designed in the connecting portion to adjoin to each other. The rods 30 extend starting form the cylindrical longitudinal portion 11 of the centrifugal screw 10 up to the portion 12 at the solid-discharge end. In particular, the rods 30 extend almost up to the connecting portion 53.

Furthermore, different diameter specifications may be recognized. The ratio (Dk/Da) of the diameter of the screw hub Dk up to the outer diameter of the screw spiral Da preferably is 0.6, in particular 0.5, particularly preferred 0.4.

The ratio (Ds/Da) of the diameter of the (imaginary) circle Ds, on which the rods 30 are arranged, to the outer diameter of the screw spiral Da preferably is 0.8, in particular 0.7, particularly preferred 0.6.

The ratio Dst/Da of a diameter of a rod Dst to the outer diameter of the screw spiral Da preferably is 0.15, in particular 0.1, particularly preferred 0.05.

The rods 30 are arranged to be in parallel to one another. In particular, the rods 30 are arranged to be in parallel to one another as well in parallel to the longitudinal axis L of the screw hub 15.

In FIG. 3, a special realization of the screw spiral 20 is represented. The screw spiral 20 is directly attached to the tube-shaped screw hub 15 or the outside 18 only at least in sections with the spiral base 21. The openings 29 of the screw spiral 20 are designed to be longitudinal recesses. The longitudinal recesses 29 are shaped such that the width of the recesses decreases starting from the spiral basis 21 in the direction of the spiral tip 22. This facilitates mounting and introducing the rods 30 into the openings 29. The rods 30 may be pushed out to the outside from the direction of the screw hub 15 in the direction of the spiral tip 22. The dimension of the most minimal width of the opening 29 is dimensioned such that the rods 30 can be attached to be clamping within the openings 29.

In FIG. 3 moreover, such an embodiment of a centrifugal screw 10 is represented, according to which the portion 12 at the solid-discharge end is designed in the shape of two truncated cones 51 and 52 adjoining each other. The rods 30 extend up to the area of the first truncated cone 51. The Figure shows the ends 33 of the rods 30 lying at the outside of the first truncated cone 51.

In FIG. 4, such an embodiment of a centrifugal screw 10 is represented which is further developed with respect to the embodiment shown in FIG. 3.

In the cylindrical longitudinal portion 11 of the centrifugal screw 10 metal sheets 60 are designed between the individual rod portions 31 and the screw hub 15 or the outside 18 of the screw hub 15.

A portion of the rod 30 has always to be understood to be a rod portion 31 designed between two winding portions 25. The metal sheet 60, for example, is welded to the rod portions 31 and the outside 18 of the screw hub 15.

The metal sheets 60 serve for further stabilizing the centrifugal screw 10. The metal sheets 60 are preferably arranged in such a portion of the cylindrical longitudinal portion 11 which is arranged in the proximity of the first frontal side 41.

Seen in the longitudinal direction R, the metal sheets 60 are preferably designed in a first third of the cylindrical longitudinal portion 11. It is possible for the metal sheets 60 to be designed in this first third, in particular in a first quarter, of the cylindrical longitudinal portion 11 between all of the rod portions 31 designed there and the screw hub 15.

As represented in FIG. 4, the metal sheets 60 have openings 61 forming an opening pattern. The openings 61, on the one hand, serve for reducing the weight of the metal sheets 60. Furthermore, the flow properties within the drum of a solid bowl screw centrifuge (not represented) are improved.

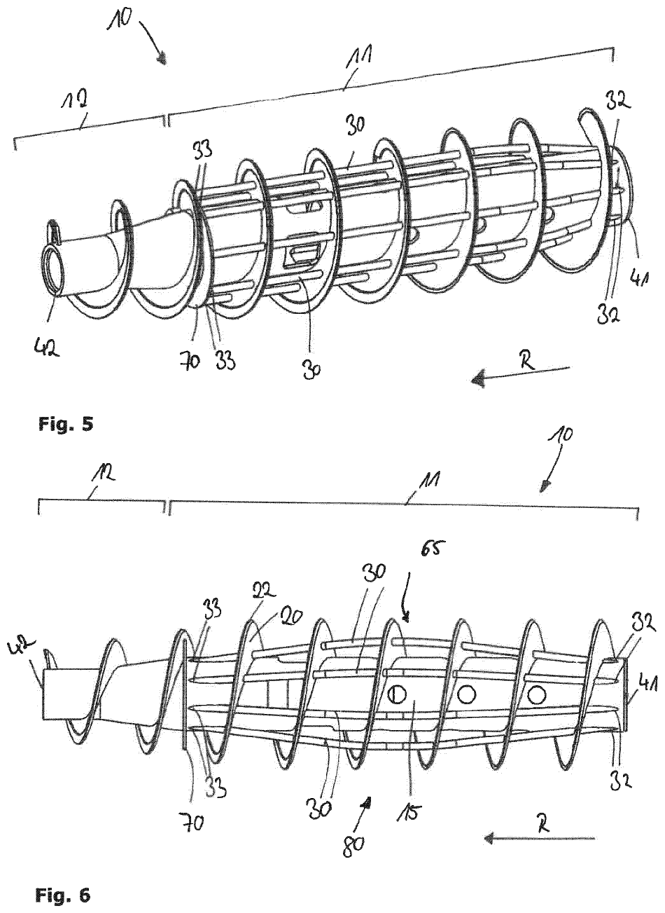

In FIG. 5, a centrifugal screw 10 is illustrated having portion 12 at the solid-discharge end that is simply designed. In the represented example, the portion 12 at the solid-discharge end essentially consists of a cone-shaped envelope surface.

In the cylindrical longitudinal portion 11, the rods 30 are bent at least in sections. In particular, the ends of the rods 30 pointing into the direction of the first frontal side 41 of the screw hub 15, are bent. The ends 33 of the rods 30 are not bent. The ends 33 are in the present example attached to a transverse disc 70. The rods 30 are arranged to be essentially spaced from the screw hub 15. Only the ends 32 of the rods 30 fit closely for being fixed to the screw hub 15. In FIG. 5, an embodiment of the invention is shown illustrating an almost complete spacing of the rods 30 from the screw hub 15.

In FIG. 6, a further embodiment with respect to bent rods 30 is represented. In the illustrated example, both the ends 32 of the rods 30, and the ends 33 of the rods 30 are designed to be fixed to the screw bub 15. Due to bending the rods 30 such that the ends 32 and 33 each are bent pointing into the direction of the screw hub 15, such a rod body 65 is formed, the largest outer diameter of which is designed in a middle segment 80 of the centrifugal screw 10.

Such a portion of the centrifugal screw 10 has to be understood to be a middle segment 80, that is designed to be spaced both from the first frontal side 41 and the second frontal side 42. The rod body 65 is not to be understood to be a continuous body. Rather, the structure of the bent rods 30 is arranged relative to one another such that a kind of body is formed.

The rod body 65 represented in FIG. 6 has a spindle-shape. The convexities are thus designed to be approximately central to the course of the rods from the ends 32 up to the ends 33.

It should be noted in conclusion that all of the features mentioned in the documents of application and in particular in the dependent claims, despite the formal back reference made to one or several certain claim/s, should receive an autonomous protection even singly or in any arbitrary combination.

### LIST OF REFERENCE NUMERALS

10 centrifugal screw
11 cylindrical longitudinal portion
12 portion at the solid-discharge end
15 screw hub
16 opening
17 inflow area
18 outside
20 screw spiral
21 spiral basis
22 spiral tip
23 front side
24 rear side
25, 25′, 25″ winding portion
28 opening
29 opening
30 rod
31 rod portion
32 end of the rod
33 end of the rod
40 bearing reception
41 first frontal side
42 second frontal side
51 first truncated cone
52 second truncated cone
53 connecting portion
60 metal sheet
61 opening
65 rod body
70 transverse disc
80 middle segment
R longitudinal direction
L longitudinal axis
Da outer diameter of screw spiral
Dk diameter of screw hub
Ds diameter of circle of rods
Dst diameter of one rod

1. A centrifugal screw (10) having an essentially tube-shaped screw hub (15) and a screw spiral (20), wherein a spiral basis (21) of the screw spiral (20) at least in sections is directly attached to the tube-shaped screw hub (15),
characterized in that
rods (30) are designed in the longitudinal direction (R) of the centrifugal screw (10) between at least two winding portions (25), wherein the rods (30) are designed to be spaced completely or almost completely from the screw hub (15).

2. The centrifugal screw (10) according to claim 1,
characterized in that
the rods (30) extend across several winding portions (25, 25′, 25″).

3. The centrifugal screw (10) according to claim 1,
characterized in that
the rods (30) are designed to be in parallel and/or similar to each other.

4. The centrifugal screw (10) according to claim 1,
characterized in that
the rods (30) are guided through openings (28, 29) of the screw spiral (20), wherein the openings (28) preferably are circular and/or elliptical and/or cam-shaped and/or are designed as longitudinal recesses (29) starting from the spiral basis (21).

5. The centrifugal screw (10) according to claim 1,
characterized in that
the ratio (Dk/Da) of the diameter of the screw hub (Dk) to the outer diameter of the screw spiral (Da) is 0.6, in particular 0.5, particularly preferred 0.4.

6. The centrifugal screw (10) according to claim 1,
characterized in that
the ratio (Ds/Da) of the diameter of the circle (Ds), where the rods (30) are arranged, to the outer diameter of the screw spiral (Da) is 0.8, in particular 0.7, particularly preferred 0.6.

7. The centrifugal screw (10) according to claim 1,
characterized in that
the ratio (Dst/Da) of the diameter of one rod (Dst) to the outer diameter of the screw spiral (Da) is 0.15, in particular 0.1, particularly preferred 0.05.

8. The centrifugal screw (10) according to claim 1,
characterized in that
the rods (30) extend essentially completely across a cylindrical longitudinal portion (11) of the centrifugal screw (10).

9. The centrifugal screw (10) according to claim 1,
characterized in that
the rods (30) extend at least in sections starting from a/the cylindrical longitudinal portion (11) of the centrifugal screw (10) up to the portion (12) at the solid-discharging end of the centrifugal screw (10).

10. The centrifugal screw (10) according to claim 1,
characterized in that
metal sheets (60) are designed in sections between the screw hub (15) and individual rods (30) and/or rod portions (31).

11. The centrifugal screw (10) according to claim 10,
characterized in that
at least one of the metal sheets (60) has at least one metal sheet opening (61), preferably is designed to be perforated.

12. The centrifugal screw (10) according to claim 1,
characterized in that
the rods (30) are designed to be bent at least in sections, wherein the bent rods (30) preferably are positioned such in the longitudinal direction (R) of the centrifugal screw (10), that the bent rods (30) form a rod body (65), the largest outer diameter of which is designed in a middle segment (80) of the centrifugal screw (10).

13. The centrifugal screw (10) according to claim 12,
characterized in that
the rods (30) each are bent at several places such that several bending portions are formed.

14. The centrifugal screw (10) according to claim 1,
characterized in that
the screw hub (15) is designed as a slotted screw hub or as a tube screw hub.

15. A solid bowl screw centrifuge comprising a centrifugal screw (10) located within a drum, wherein the centrifugal screw (10) is designed according to claim 1.
